(19) United States
(12) Patent Application Publication
(10) Pub. No.: US 2006/0245988 A1
(43) Pub. Date: Nov. 2, 2006

(54) Ceramic nanoreactor having controlled parameters and method for making same

(75) Inventors: Sergio Martins Loureiro, Saratoga Springs, NY (US); Anthony Yu-Chung Ku, Rexford, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/116,686

(22) Filed: Apr. 27, 2005

(51) Int. Cl. B01J 8/02; B01J 35/02

(52) U.S. Cl. 422/211

(57) ABSTRACT

A nanoreactor assembly and method for making the same are described. The nanoreactor assembly includes a ceramic structure with at least one opening, and a porous filler material having a plurality of regions and being disposed within the at least one opening. Each of the regions are architecturally engineered to include at least one specific pore architecture. Each of the specific pore architectures are chosen to enable a chemical process to be performed within said ceramic structure. The method includes providing a ceramic structure that has at least one opening, introducing a porous filler material into the at least one opening, and introducing at least one chemical to the nanoreactor assembly.

### BACKGROUND

The invention relates generally to the field of nanoreactors formed of ceramic compositions. More specifically, the invention relates to ceramic nanoreactors with architecturally engineered parameters and methods for making the same.

Membranes having pores that possess a tightly controlled size distribution that is in the nanoscale length range are known to be useful as filters for separations, catalytic hosts, and sensor components. Such membranes may be produced using surfactant-templated approaches. A tightly controlled size distribution is desirable in that it provides a diffusion profile having reduced dispersion relative to a broader size distribution. Such membranes are useful in reactive separations, water purification, or removal of heavy metals and/or biological contaminants. Moreover, a tightly controlled size distribution is useful for size-based exclusion. Such membranes are useful in a variety of applications, such as, for example, in filters for separations.

In the design of chemical reactors, control over material flow through the reactor is important for assuring a desired degree of selectivity and/or conversion. For example, uncontrolled fluid bypass decreases, and stagnant regions increase, the time a molecule remains in the reactive region. In multi-step reactions, it is often advantageous to guide the material progressively through reactive regions that each promote a step in the overall reaction. This can be accomplished by engineering the fluid transport through the structure of the reactor.

It is known to architecturally engineer parameters of ceramic structures. See, for example, U.S. patent application Ser. No. 10/983,277, filed Nov. 8, 2004 with a priority date of May 28, 2004, and entitled “Ceramic Structures and Methods of Making Them,” commonly owned by assignee of the present patent application.

It is desirable to utilize architecturally engineered ceramic structures to form nanoreactor assemblies capable of performing chemical reactions in the nanoscale.

### SUMMARY

Embodiments of the invention provide a nanoreactor assembly that includes a ceramic structure comprising at least one opening therethrough and a porous filler material that has a plurality of regions and is disposed within the at least one opening. Each region is architecturally engineered to include at least one specific pore architecture, and the specific pore architectures are chosen to enable a chemical process to be performed within the ceramic structure.

One aspect of the invention provides a nanoreactor assembly that includes a scaffold with openings, and a porous filler material. The porous filler material includes a plurality of regions, is disposed within the openings, and includes at least one doped or undoped composition from the group consisting of an oxide, a borate, an aluminate, a silicate, a phosphate, and any combination thereof. Each of the regions is architecturally engineered to include at least one specific pore architecture. The specific pore architectures are chosen to enable a chemical process to be performed within the membrane.

Embodiments of the invention provide a method for performing a chemical process within a nanoreactor assembly. The method includes providing a ceramic structure that includes at least one opening therethrough, introducing a porous filler material into the at least one opening, and introducing at least one chemical to the nanoreactor assembly. The porous filler material includes a plurality of regions and each of the regions includes at least one specific pore architecture chosen to enable a chemical process to be performed within the ceramic structure.

These and other advantages and features will be more readily understood from the following detailed description of preferred embodiments of the invention that is provided in connection with the accompanying drawings.

### BRIEF DESCRIPTION OF THE DRAWINGS

FIG. 1 is a perspective view of a membrane constructed in accordance with an embodiment of the invention.

FIG. 2 illustrates two exemplary architectures of porous filler material that may be utilized in the structure of FIG. 1.

FIG. 3 illustrates an architecture of porous filler material within one opening of the structure of FIG. 1.

FIG. 4a is a cross-sectional view taken along line IVa-IVa of FIG. 1.

FIG. 4b is a plan view showing porous filler material in the structure of FIG. 1.

FIGS. 5a-5b are close-up plan views showing multiple regions of different pore connectivity in accordance with an embodiment of the invention.

FIGS. 6a-6b are cross-sectional views showing multiple regions of different pore connectivity in accordance with an embodiment of the invention.

FIGS. 7a-7f illustrate various components for a nanoreactor having a cubic architecture in accordance with an embodiment of the invention.

FIG. 8a illustrates a hybrid component for a nanoreactor having both cubic and hexagonal architectures in accordance with an embodiment of the invention.

FIG. 8b illustrates an array of the hybrid components of FIG. 8a.

FIG. 9a illustrates a nanoreactor assembly constructed in accordance with an embodiment of the invention.

FIG. 9b illustrates a nanoreactor assembly constructed in accordance with an embodiment of the invention.

FIG. 10 schematically illustrates a multi-region nanoreactor assembly constructed in accordance with an embodiment of the invention.

FIG. 11 schematically illustrates a multi-region nanoreactor assembly constructed in accordance with an embodiment of the invention.

FIG. 12a schematically illustrates a multi-region nanoreactor assembly constructed in accordance with an embodiment of the invention.

FIG. 12b schematically illustrates a multi-region nanoreactor assembly constructed in accordance with an embodiment of the invention.

### DETAILED DESCRIPTION OF PREFERRED EMBODIMENTS

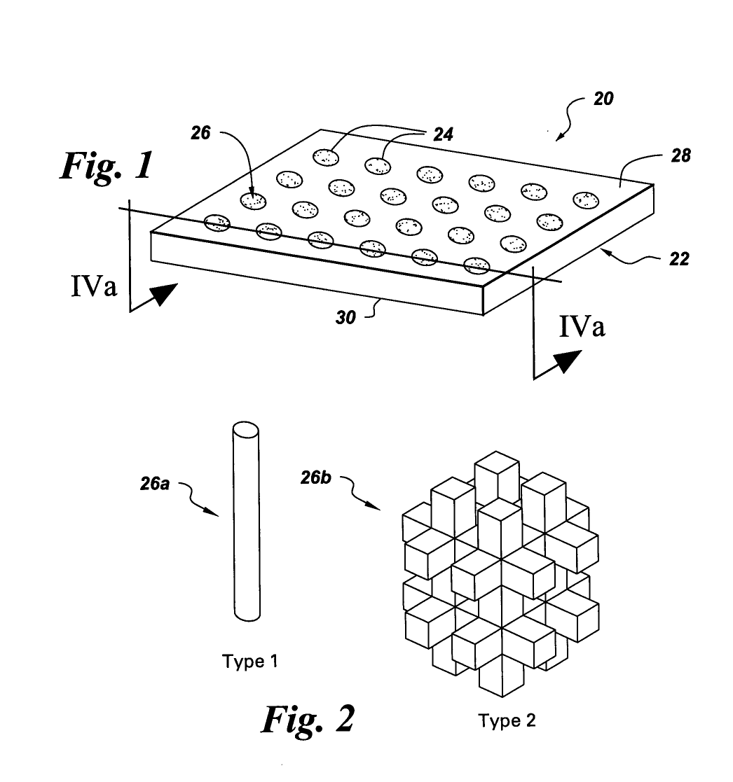

FIG. 1 is a schematic representation of a ceramic structure 20. The ceramic structure 20 may be of any suitable structure, such as, for example, a membrane, a film, or a multi-layered ceramic body. The ceramic structure 20 includes a scaffold 22, which serves as a support for multiple openings 24 that extend between a first surface 28 and a second surface 30. Each opening 24 is at least partially filled with a porous filler material 26.

The scaffold 22 provides mechanical stability. An example of a suitable scaffold 22 includes an anodic aluminum oxide (AAO) membrane with openings 24. The scaffold 22 may be formed of various materials such as glass, silica microfiber filter, quartz, and compacted ceramic powders. The scaffold 22 may be of any shape and size, such as depth, width, length, or other dimension.

The number of openings 24 in a scaffold 22 may vary. Each opening 24 may be independent of another opening 22. For example, each opening 24 may independently be filled with a porous filler material 26 independent of the porous filler material 26 that may fill another opening 24. Furthermore, the portion of an opening 24 filled with a porous filler material 26 may be independent of the portion of another opening 24 filled with a porous filler material 26. FIG. 1 depicts the openings 24 as oval or circular for ease of illustration only. Each opening 24 may be of varying dimensions, such as depth, width, length and shape.

The porous filler material 26 has a plurality of pores. The pores have an average size in a range from about 2 nm to about 100 nm. The pore size can be inferred from nitrogen adsorption measurements using a model for the adsorption process, such as for example, the Barrett-Joyner-Halenda (BJH) analysis. The term “nanoporous” as used herein means pores having a size in a range from about 1 nm to about 100 nm. Specifically, according to IUPAC, the pores are referred to as micropores when the pores are less than 2 nm. The pores are referred to as mesopores or mesoporous when the pores are in a size range from 2 nm to 50 nm. The pores are referred to as macropores or macroporous when the pores are in a size range greater than 50 nm.

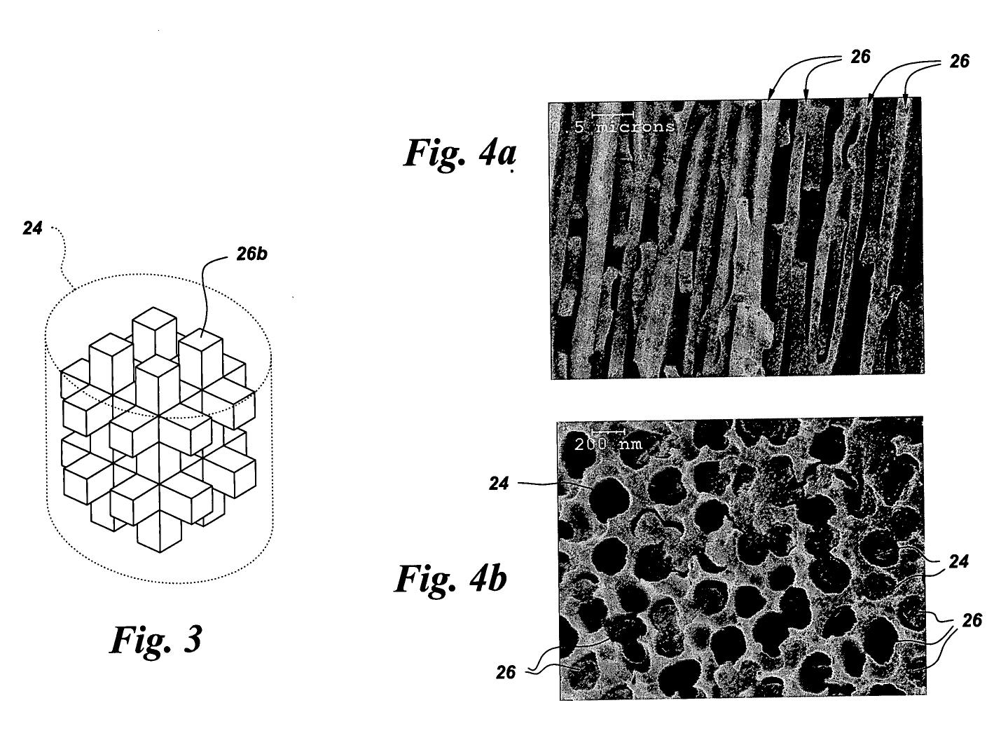

The porous filler material 26 may be architecturally engineered so as to form more than one pore architecture. A pore architecture means a plurality of pores having a size distribution (also referred as size range) and an organization. For each pore architecture, the average pore size distribution does not vary by more than about 100% when the average pore size is in a range from about 2 nm to about 50 nm (i.e. mesoporous). The average pore size distribution does not vary by more than about 50% when the average pore size is greater than about 50 nm (i.e. macroporous). The pores comprise at least two pore architectures when the porous filler material 26 is a single silica composition (i.e. only silica composition). Pore organization refers to the type of pore phase in the porous filler material 26, and can assume periodic and non-periodic arrangements, as determined by diffraction (X-ray, neutron, synchrotron), microscopy (transmission electron, scanning electron), and spectroscopic (electron energy loss) techniques. Examples of pore organization include, but are not limited to, hexagonal organization, cubic organization, lamellar organization, bicontinuous organization, worm-like organization, ribbon organization, mesh organization, and gyroid organization. FIG. 2 schematically illustrates a hexagonal architecture or organization 26a as well as a cubic architecture or organization 26b. FIG. 3 schematically illustrates a cubic architecture 26b within a single opening 24.

The porous filler material 26 comprises at least one wall composition. In one embodiment, the composition of the porous filler material 26 may either comprise an oxide, a borate, an aluminate, a silicate, and a phosphate, individually or in any combination thereof. In one embodiment, the porous filler material 26 comprises an oxide. Examples of oxides include, but are not limited to, SiO₂, TiO₂, Al₂O₃, ZrO₂, Nb₂O₃, Ta₂O₅WO₃, SnO₂, HfO₂, SrAlO₃, SiTiO₄, ZrTiO₄, Al₂TiO₅, ZrW₂O₈, CeO₂, yttria stabilized zirconia, Y₂O₃, in their stoichiometric or non-stoichiometric forms, either individually or in any combination thereof. In one embodiment, the porous filler material 26 includes a plurality of compositions. The plurality of compositions may comprise any combination of the materials listed above. Furthermore, the composition may be doped with a lanthanide, a transition metal, or any combination thereof. Dopings may induce optical emission within the wall of the filler material by impurity-activated luminescence. Impurity-activated luminescence occurs when a non-luminescent host material has been modified by inclusion of an activator species (i.e., a dopant) which is typically present in the host material in a relatively low concentration, such as, for example, from about 200 parts per million to 1 part per thousand. However, some materials require several mole or atomic percentage of dopant ions for optimized optical properties. With an impurity-activated luminescent material, the activator ions may either absorb the incident photons directly, or the lattice may absorb the incident photons and transfer the absorbed photon energy to the dopant ions. Examples of such dopants include, but are not limited to, Ce, Pr, Nd, Eu, Th and Cr. Furthermore, the porous filler material may include a portion or the total number of pores being functionalized with compositions necessary to promote/enhance chemical processes. Examples of pore functionalizing materials include, but are not limited to, palladium, platinum, gold, iridium, rhodium, ruthenium, and rhenium. In one embodiment, the porous filler material 26 fills at least 50% of each opening 24. In another embodiment, a portion of an opening 24 is unfilled by the porous filler material 26.

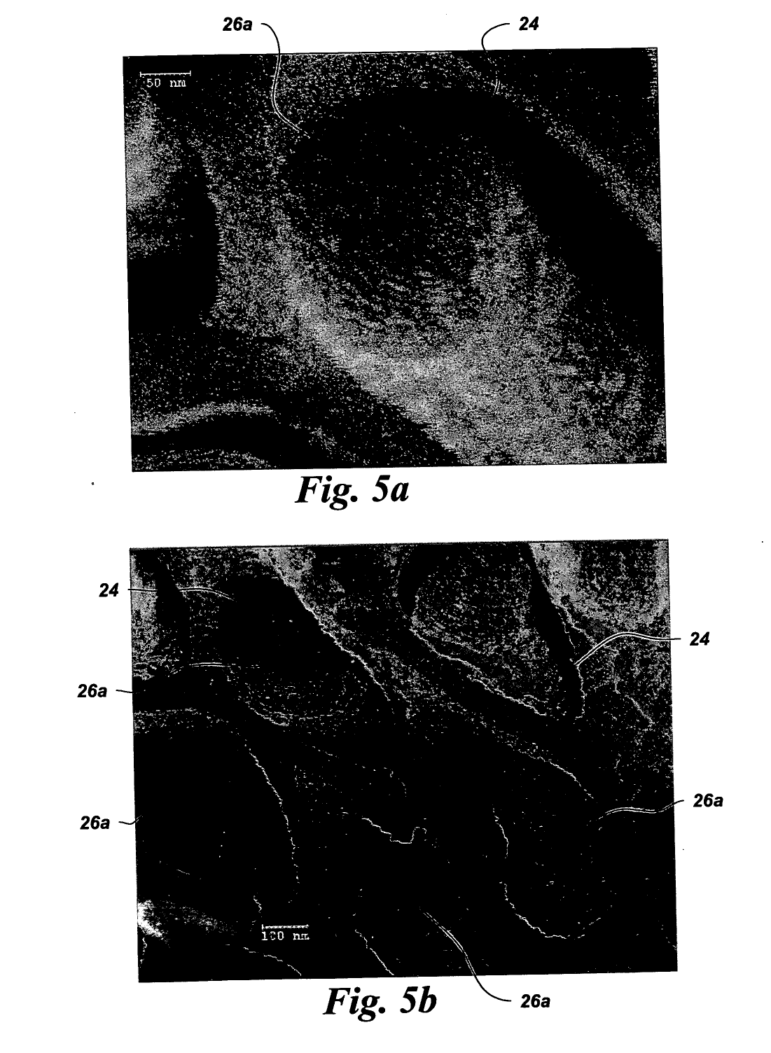

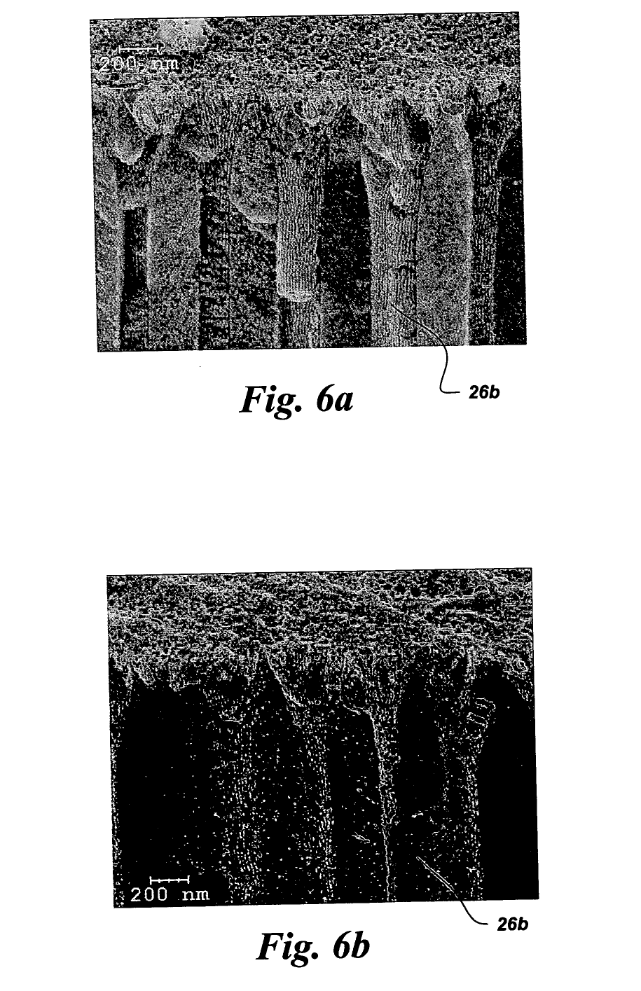

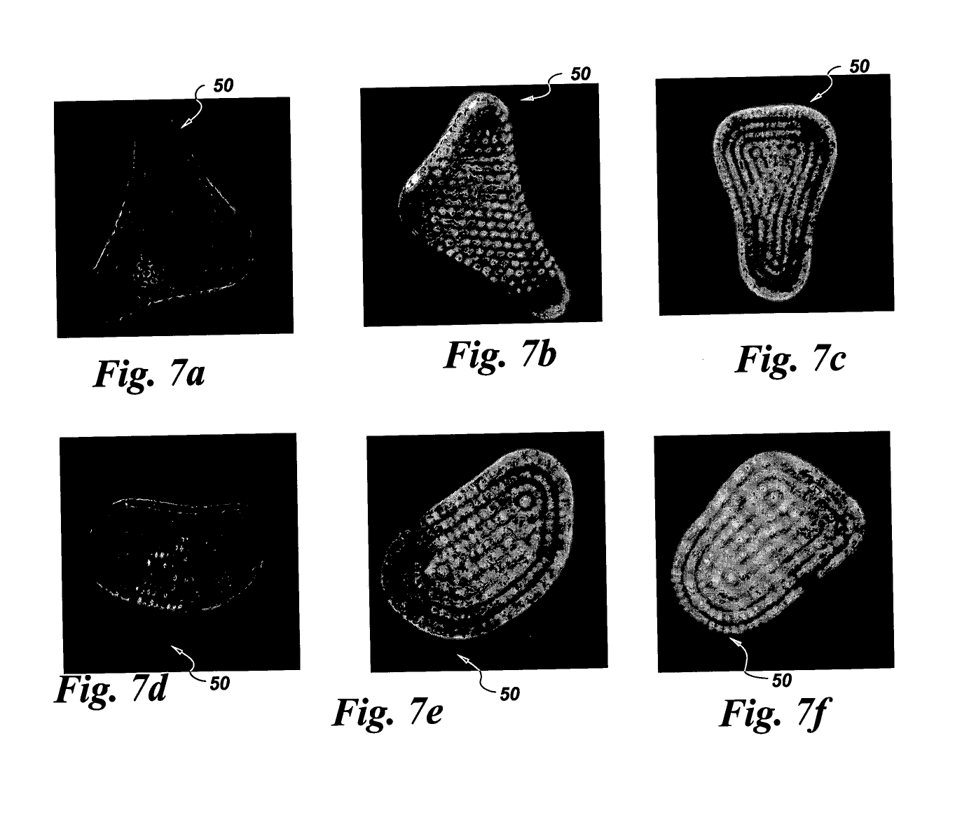

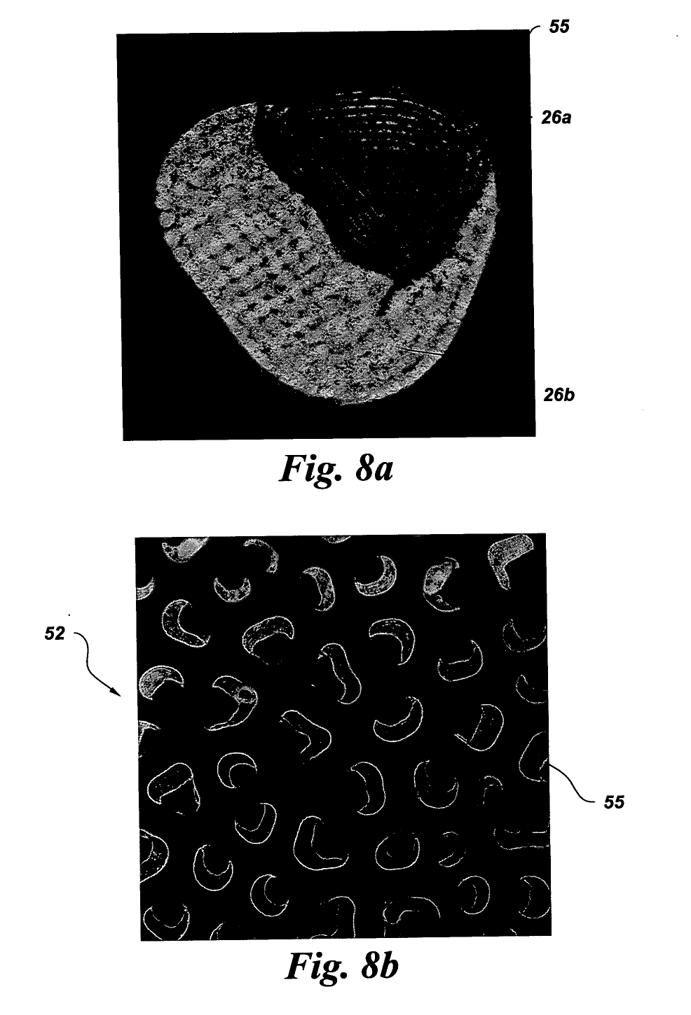

FIG. 4a is an expanded cross-sectional view of the ceramic structure 20 of FIG. 1, showing the porous filler material 26. FIG. 4b shows the porous filler material 26 within the openings 24. FIGS. 5a and 5b are expanded views of the ceramic structure 20 showing a hexagonal architecture 26a within the openings 24. FIGS. 6a-b illustrate, at very high magnification, cubic architecture 26b. FIGS. 7a-f illustrate via small area transmission electron microscopy (TEM) nanoreactor components 50 having a cubic architecture. FIG. 8a illustrates a hybrid nanoreactor component 55, which includes both the hexagonal architecture 26a and the cubic architecture 26b. FIG. 8b illustrates via large area TEM an array 52 of hybrid nanoreactor components 55.

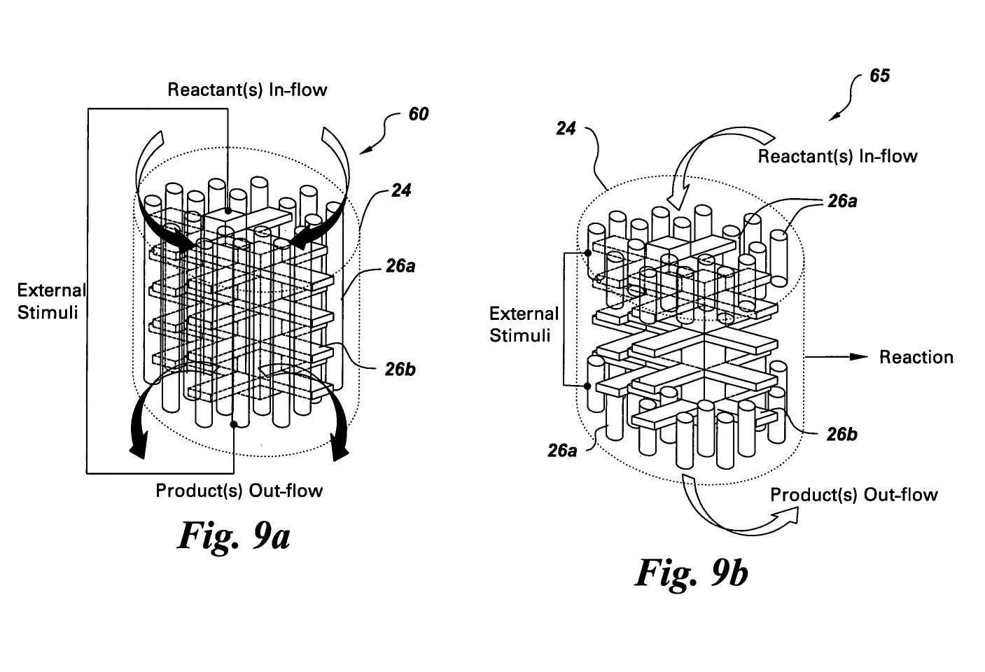

Next will be described, with specific reference to FIG. 9a, a nanoreactor assembly 60 constructed in accordance with an embodiment of the invention. The nanoreactor assembly 60 includes porous filler material within a single opening 24. Specifically, there is disposed a ring of hexagonal architecture 26a porous filler material surrounding cubic architecture 26b porous filler material. As a chemical mixture of reactants is introduced to the opening 24, due to various parameters, such as capillary action, diffusion due to a concentration gradient, flow due to a pressure gradient, flow due to an external stimulus (for example, electric fields can cause electrolyte fluid flow through electro-osmosis), the chemical mixture is driven to enter through the hexagonal architecture 26a porous filler material and the cubic architecture 26b porous filler material. A catalyst may be deposited in either or both of the materials, resulting in reaction of the chemical mixture as it passes through the opening 24. The pore size distributions of the architectures 26a and 26b can be further controlled to promote different transport rates of different species based on molecular size, polarity, or other chemical differences. For example, if the pores of architecture 26a are smaller than the pores of architecture 26b, some larger molecular species may be excluded from the architecture 26a. The chemical mixture is transported from one pore architecture to another within the membrane or scaffold 22, and an opportunity exists for a chemical process to occur within the membrane 22 as well. The chemical processing may be a chemical reaction (homogeneous or heterogeneous) or a chemical separation.

Nanoreactors enable control to be exerted over conversion and selectivity. For example, the conversion of a heterogeneous (catalyzed) reaction is a function of the residence time of the chemical mixture. Longer residence times allow a reaction to approach equilibrium conversion. In nanoreactors, it is possible to obtain greater than equilibrium conversion by removing one of the products as the reaction is occurring.

Another advantage of nanoreactors is control over selectivity. In some cases, several possible products may be possible from a given set of reagents for a known catalyst. The selectivity can be tuned by the relative concentrations of the reagents, or through the residence time in the catalytic region. In nanoporous materials, it is possible to shrink the residence time to access new regimes. Specifically, for nanoporous regions of size 100 nm, it is possible to get residence times less than microseconds. It should be appreciated that along with the ability for chemical processing within the membrane 22 is the ability for energy transfer. For example, during a chemical reaction, often there is a change in energy state, either an exothermic change or an endothermic change. Depending upon the circumstances of the desired chemical processing, the nanoreactor assembly can be configured to take into account the energy transfer component. For example, relative sizes of regions may be tuned to produce and consume heat in order to drive an effectively isothermal process. Additionally, the inclusion of an external stimulus, for example, an externally driven electric field, can drive an electrolyte solution through the nanoreactor assembly.

A nanoreactor assembly 65 is schematically illustrated in FIG. 9b as including a pair of hexagonal architecture 26a porous filler material areas sandwiching an area of cubic architecture 26b porous filler material. The chemical mixture is transported through the first area of hexagonal architecture 26a porous filler material to become resident within the cubic architecture 26b porous filler material, where a chemical process takes place. Then, the chemical mixture, or any of its constituent parts, exits the nanoreactor assembly 65 by transporting through the second area of hexagonal architecture 26a porous filler material. It should be appreciated that architecture 26a may have a different pore size than architecture 26b. By having two architectures 26a, 26b, each having a pore size different than the other, the ability to have a chemical separation within the nanoreactor assembly 65 is enhanced. For example, if architecture 26a has pore sizes that are smaller than those in architecture 26b, the product of a chemical reaction ongoing within the nanoreactor assembly 65, but not the reagents, may be small enough to pass through the architecture 26a.

For purposes of illustrative description only, next will be described specific examples of chemical processing that may be performed within a nanoreactor assembly, such as those described herein. A chemical mixture of two chemicals, A and B, is added to a nanoreactor assembly. The molecules of chemical A are smaller than those of chemical B, but more reactive. Thus, the concentration of chemical A must be kept low to inhibit side reactions. The chemical mixture of A+B is added to the architecture 26b, which contains a catalyst for the equation A+B→C. As the chemical mixture of A+B transports through the architectures, the mixture becomes depleted in the chemicals A and B, but enriched in the chemical C. Chemical A is more dilute than chemical B because chemical A is highly reactive, so keeping it in low concentrations prevents side reactions. Since chemical A is more dilute than chemical B, it will become depleted sooner than chemical B. However, if architecture 26a contains pores small enough to exclude chemicals B and C, but large enough to allow transport of chemical A, a greater amount of chemical A can be delivered to the chemical mixture, therefore allowing a greater conversion rate. While the key benefit of pore size in this example is conversion rate, such tuning also improves selectivity.

Specific examples of chemicals A, B and C may include:
A=H₂;
B═CₓH₂ₓ; and
C═CₓH₂ₓ₊₂.
The above example of chemicals would allow a hydrogenation reaction to occur within the nanoreactor assembly. Alternatively, if a feed chemical C═CₓH₂ₓ₊₂ is added to the nanoreactor assembly, a dehydrogenation reaction (C→A+B) can occur within the nanoreactor assembly, where A=H₂ and B═CₓH₂ₓ. The chemical C may be selectively removed by transport through architecture 26b.

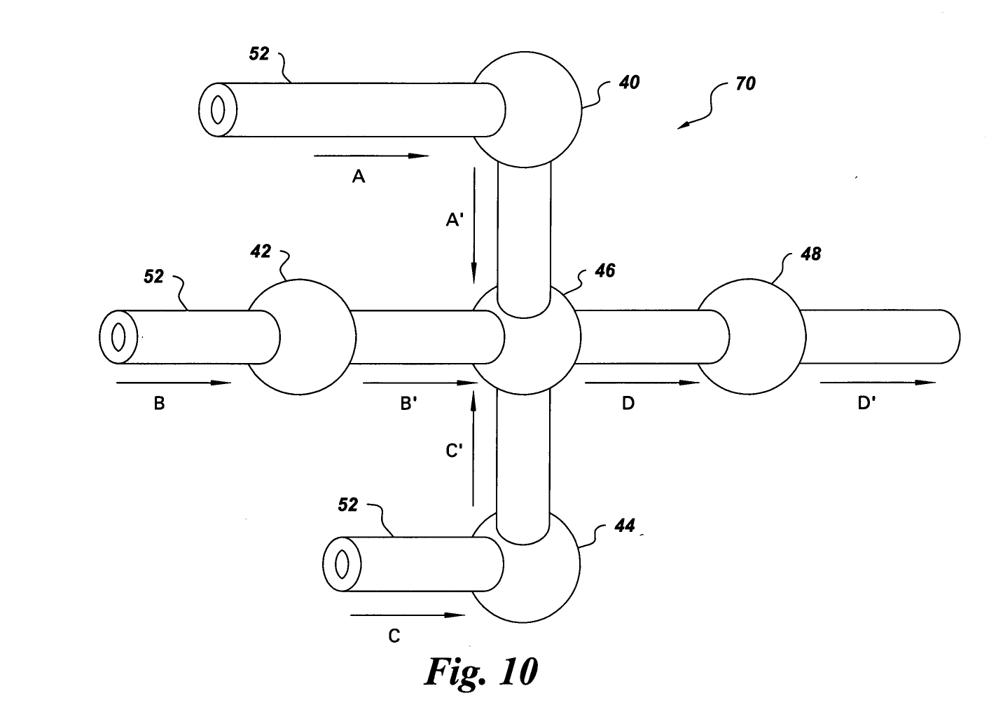

Next, with reference to FIGS. 10-12, will be described various nanoreactor assembly embodiments. It should be appreciated that the nanoreactor assemblies in FIGS. 10-12 are schematically illustrated for ease of describing the various flow and regime permutations possible within such nanoreactor assemblies. Referring specifically to FIG. 10, a nanoreactor assembly 70 is schematically illustrated. The nanoreactor assembly 70 includes a plurality of nanoreactor arrays 52, each leading to a reacting region. Specifically, a first nanoreactor array 52, through which a first chemical A is introduced, extends to a first region 40. A second nanoreactor array 52, through which a second chemical B is introduced, extends to a second region 42, and a third nanoreactor array 52, through which a third chemical C is introduced, extends to a third region 44. The first, second and third chemicals A, B, and C respectfully react with one another within the first, second and third regions 40, 42 and 44. The regions 40, 42 and 44 are engineered so that, respectively, first, second and third reacted chemicals A′, B′ and C′ exit. A mixing region 46 is provided to receive the first, second and third reacted chemicals A′, B′ and C′, in which they react to form an exiting chemical mixture D. Finally, a fourth region 48 receives the exiting chemical mixture D, in which it reacts, and an output chemical mixture D′ results. While chemical processing has been described as occurring within regions 40, 42, 44, 46, and 48, it should be appreciated that chemical processing also may occur in nanoreactor arrays 52.

It should also be appreciated that the pore architectures of embodiments of the nanoreactor assembly may be tuned to enable the chemical process to be performed within the ceramic structure 22. The tuning may include adjusting one or more of the following: (a) pore size within the porous filler material, (b) the type of pore architecture, (c) the size of the regions, (d) the number of regions, (e) the number and type of pore architectures per each region, (f) the composition of the walls of the at least one opening, (g) the presence of a functionalizing treatment on the walls of the at least one opening or in pores of the porous filler material, and (h) the connectivity between the regions.

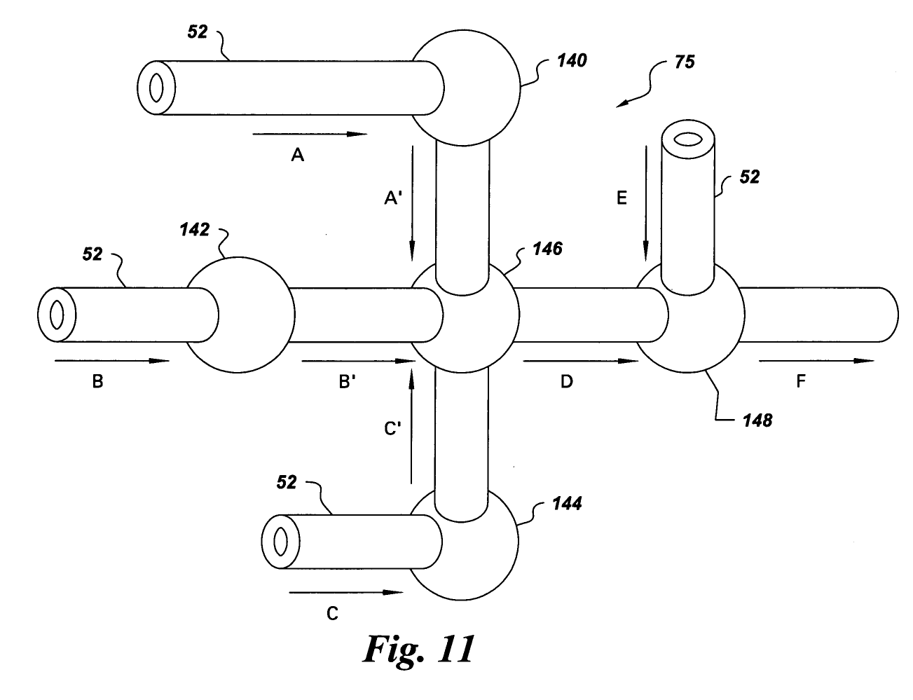

FIG. 11 schematically illustrates- a nanoreactor assembly 75. The nanoreactor assembly 75 includes a plurality of nanoreactor arrays 52, each leading to a reacting region. Specifically, a first nanoreactor array 52, through which a first chemical A is introduced, extends to a first region 140. A second nanoreactor array 52, through which a second chemical B is introduced, extends to a second region 142. A third nanoreactor array 52, through which a third chemical C is introduced, extends to a third region 144, and a fourth nanoreactor array 52, through which a fourth chemical E is introduced, extends to a fourth region 148. The first, second and third chemicals A, B, and C respectfully react with one another within the first, second and third regions 140, 142 and 144. The regions 140, 142 and 144 are engineered so that, respectively, first, second and third reacted chemicals A′, B′ and C′ exit. A mixing region 146 is provided to receive the first, second and third reacted chemicals A′, B′ and C′, in which they react to form an exiting chemical mixture D. The exiting chemical mixture D is introduced to the fourth region 148, along with the fourth chemical E, and an output chemical mixture F results.

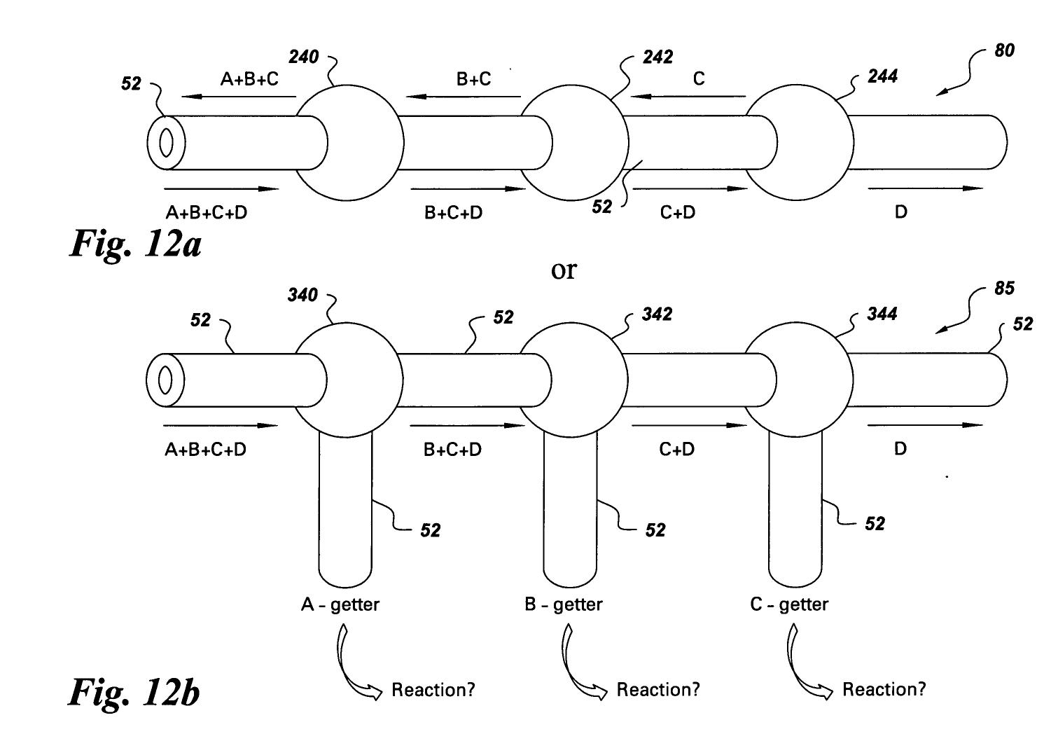

Next, with specific reference to FIG. 12a, will be described nanoreactor assembly 80, which is useful in a separation process. As illustrated, the nanoreactor assembly 80 includes a plurality of nanoreactor arrays 52, each leading to either a reacting region or exiting the assembly. The nanoreactor assembly 80 includes a first region 240, a second region 242, and a third region 244. As shown, a chemical mixture including chemicals A-D is introduced into a nanoreactor array 52 leading to the first region 240. In the first region 240, the chemical A is retained for a greater period of time than the chemicals B-D, which continue through to the second region 242. The second region 242 is configured to retain chemical B for a greater period of time than the chemicals C-D, which continue through to the third region 244. The third region 244 is configured to retain chemical C, allowing chemical D to exit the nanoreactor assembly 80.

Referring specifically to FIG. 12b, there is shown a nanoreactor assembly 85, which includes a plurality of nanoreactor arrays 52 and a plurality of reacting regions. Specifically, there is shown a first region 340, a second region 342, and a third region 344. As with the nanoreactor assembly 80 (FIG. 12a), the nanoreactor assembly 85 is configured to separate chemicals. Specifically, a chemical mixture containing chemicals A-D is introduced into a nanoreactor array 52 leading to the first region 340. The first region 340 is configured to allow separation of chemical A from chemicals B-D, allowing chemical A to exit from the first region 340 separately than chemicals B-D. The remaining chemicals B-D are then introduced to the second region 342, which is configured to separate chemical B from chemicals C-D. Chemical B exits the second region 342 separately than chemicals C-D, which are then introduced to the third region 344. The third region 344 is configured to allow separation of chemical C from chemical D, each chemical exiting the third region 344 separately.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, while embodiments of the invention have been described as including a ceramic structure, it should be appreciated that structures formed of other materials may be suitable, such as, hybrid materials, polymers, and metals. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A nanoreactor assembly, comprising:
a structure comprising at least one opening therethrough; and
a porous filler material comprising a plurality of regions and being disposed within said at least one opening, wherein each said region is architecturally engineered to include at least one specific pore architecture and wherein said specific pore architectures are chosen to enable a chemical process to be performed within said structure.

2. The nanoreactor assembly of claim 1, wherein said structure comprises one from the group consisting of a membrane, a film, and a multi-layered ceramic body.

3. The nanoreactor assembly of claim 1, wherein said structure comprises a ceramic material.

4. The nanoreactor assembly of claim 1, wherein said structure comprises a scaffold.

5. The nanoreactor assembly of claim 4, wherein said scaffold serves as a support for said at least one opening.

6. The nanoreactor assembly of claim 4, wherein said scaffold comprises an anodic aluminum oxide membrane.

7. The nanoreactor assembly of claim 1, wherein said porous filler material comprises at least one doped or undoped composition from the group consisting of an oxide, a borate, an aluminate, a silicate, a phosphate, and any combination thereof.

8. The nanoreactor assembly of claim 1, wherein said at least one specific pore architecture comprises at least one architecture from the group consisting of a hexagonal organization, a cubic organization, a lamellar organization, a bicontinuous organization, a worm-like organization, a ribbon organization, a mesh organization, and a gyroid organization.

9. A nanoreactor assembly, comprising:
a structure having openings; and
a porous filler material comprising a plurality of regions and being disposed within said openings, wherein:
each said region is architecturally engineered to include at least one specific pore architecture, wherein:
said at least one specific pore architecture comprises at least one architecture from the group consisting of a hexagonal organization, a cubic organization, a lamellar organization, a bicontinuous organization, a worm-like organization, a ribbon organization, a mesh organization, and a gyroid organization,
said porous filler material comprises at least one doped or undoped composition from the group consisting of an oxide, a borate, an aluminate, a silicate, a phosphate, and any combination thereof, and
said at least one specific pore architecture is chosen to enable a chemical process to be performed within said structure.

10. The nanoreactor assembly of claim 9, wherein said structure is formed of one or more materials selected from the group consisting of ceramics, hybrid materials, polymers, and metals.

11. A method for performing a chemical process within a nanoreactor assembly, comprising:
providing a ceramic structure that includes at least one opening therethrough;
introducing a porous filler material into the at least one opening, wherein the porous filler material includes a plurality of regions and each of the regions includes at least one specific pore architecture chosen to enable a chemical process to be performed within said ceramic structure; and
introducing at least one chemical to the nanoreactor assembly.

12. The method of claim 11, further comprising tuning the assembly to enable the chemical process to be performed within said ceramic structure.

13. The method of claim 12, wherein said tuning comprises adjusting at least one from the group consisting of pore size within the porous filler material, the type of pore architecture, the size of the regions, the number of regions, the composition of the walls of the at least one opening, the presence of a functionalizing treatment on the walls of the at least one opening or in pores of the porous filler material, and the connectivity between the regions.

14. The method of claim 12, wherein said tuning comprises tuning the assembly to facilitate energy transfer within said ceramic structure.

15. The method of claim 11, wherein said providing comprises providing one from the group consisting of a membrane, a film, and a multi-layered ceramic body.

16. The method of claim 11, wherein said providing comprises providing a scaffold.

17. The method of claim 11, wherein said introducing comprises introducing porous filler material comprising at least one doped or undoped composition from the group consisting of an oxide, a borate, an aluminate, a silicate, a phosphate, and any combination thereof.

18. The method of claim 11, wherein the at least one specific pore architecture comprises at least one architecture from the group consisting of a hexagonal organization, a cubic organization, a lamellar organization, a bicontinuous organization, a worm-like organization, a ribbon organization, a mesh organization, and a gyroid organization.

19. The method of claim 11, wherein said introducing at least one chemical comprises:
introducing a first chemical to a first region to create a first processed chemical;
introducing a second chemical to a second region to create a second processed chemical; and
introducing the first and second processed chemicals to a mixing region.

20. The method of claim 19, further comprising:
introducing a third chemical to a third region to create a third processed chemical; and
introducing the third processed chemical to the mixing region with the first and second processed chemicals to create an exiting chemical mixture.

21. The method of claim 20, further comprising introducing the exiting chemical mixture to a fourth region to create an output chemical mixture.

22. The method of claim 21, further comprising introducing the exiting chemical mixture and a fourth chemical to a fourth region to create an output chemical mixture.

23. The method of claim 11, wherein said introducing at least one chemical comprises introducing an initial mixture of chemicals to an inlet of a first region to separate at least some of a first specific chemical from the initial mixture of chemicals.

24. The method of claim 23, wherein said introducing at least one chemical comprises introducing the remaining mixture of chemicals exiting the first region to a second region to separate at least some of a second specific chemical from the remaining mixture of chemicals exiting the first region.

25. The method of claim 24, wherein said introducing at least one chemical comprises introducing the remaining mixture of chemicals exiting the second region to a third region to separate at least some of a third specific chemical from the remaining mixture of chemicals exiting the second region.

26. The method of claim 25, wherein the nanoreactor assembly is configured such that:
a first portion of the initial mixture of chemicals remains in the first region, a second portion of the remaining mixture of chemicals exiting the first region remains in the second region, and a third portion of the remaining mixture of chemicals exiting the second region remains in the third region; and
the first, second and third portions transport back to the inlet of the first region or out of ceramic structure.

27. The method of claim 11, wherein said introducing at least one chemical comprises providing an external stimulus to drive said at least one chemical through the nanoreactor assembly.
